(19) United States
(12) Patent Application Publication
(10) Pub. No.: US 2015/0087358 A1
(43) Pub. Date: Mar. 26, 2015

(54) METHOD FOR SHARING STATE INFORMATION BETWEEN MAIN DEVICE AND ASSIST DEVICE

(71) Applicant: Samsung Electronics Co., Ltd., Gyeonggi-do (KR)

(72) Inventor: Mi-Jin Jeong, Gyeonggi-do (KR)

(21) Appl. No.: 14/495,708

(22) Filed: Sep. 24, 2014

(30) Foreign Application Priority Data
Sep. 24, 2013 (KR) 10-2013-0113540

(51) Int. Cl. H04M 1/60; H04M 1/725; H04M 1/02

(52) U.S. Cl. CPC H04M 1/6041; H04M 1/0202; H04M 1/7253
USPC 455/556.1

(57) ABSTRACT

A method for operating an electronic device wireless communicable with an assist device transmitting information for state synchronization about at least one function in a first situation, and suspending the transmission of the information for state synchronization in a second situation. Also, other embodiments including an electronic device wireless communicable with an assist device and a system including an electronic device and an assist device are also provided.

### PRIORITY

The present application is related to and claims priority under 35 U.S.C. §119(a) to a Korean Patent Application No. 10-2013-0113540 filed in the Korean Intellectual Property Office on Sep. 24, 2013, the contents of which are herein incorporated by reference.

### TECHNICAL FIELD

Various exemplary embodiments of the present disclosure relate to an apparatus and method for sharing state information among a plurality of devices wirelessly connected.

### BACKGROUND

With the growth of electronic and communication technologies, various types of electronic devices are being widely used in everyday life. Further, not only one electronic device is used singly but also many independent electronic devices construct one pair or set and are used for one purpose. For example, portable terminals, particularly, recent smart phones are made popular, and various accessories, i.e., assist devices associated with the smart phones are being developed.

For example, earphones, headsets, and the like are commonly used as the assist devices for the smart phones. In recent years, with the introduction of the concept of wearable computing into portable electronic devices, assist devices having forms of a wrist watch, glasses and the like are being developed and commercialized. Further, in many cases, for portability and use convenience's sake, communication between a main device such as a smart phone and the assist device such as the headset is performed based on wireless connection. For this, various short-range communication technologies can be used such as Bluetooth, Near Field Communication (NFC), Wireless Fidelity (WiFi) and the like.

If the wireless communication is performed between the main device and the assist device, the assist device itself has to supply a power source. For example, the assist device can use a battery as the power source. In this case, the degree of electric power consumption of the assist device has direct influence on a device operable time of the assist device, because the available electric energy of the assist device is restricted. Resultantly, this occupies a significant proportion on the performance of user's bodily sensation.

### SUMMARY

A method for operating an electronic device communicating with an assist device includes coupling the electronic device and the assist device, receiving a signal for an incoming call by the electronic device, synchronizing the reception of the signal with the assist device, determining through which one of the electronic device and the assist device a user attempts to receive the incoming call, after the user selects the assist device for the incoming call, synchronizing data of the incoming call with the assist device, and after the user selects the electronic device for the incoming call, suspending the synchronization of the data of the incoming call with the assist device.

In some embodiments, the assist device is a wearable device.

In some embodiments claim, the wearable device is a wireless communicable watch.

In some embodiments, after the user selects the assist device for the incoming call, upon detecting an end of the incoming call, the electronic device synchronizes the end of the call with the assist device.

In some embodiments, the selection of the electronic device comprises at least one of situations of receiving a call through the electronic device, that a microphone installed in the electronic device is activated for audio input for the call, that a speaker installed in the electronic device is activated for audio output for the call, and initiating a call through the electronic device.

In some embodiments, the selection of the electronic device comprises a situation of receiving a request for suspending of provision of the information for state synchronization, from the assist device.

In some embodiments, synchronizing the reception of the signal comprises notifying the assist device of receiving the signal of the incoming call.

In some embodiments, the method further includes determining through which one of the electronic device and the assist device the user attempts to initiating an outgoing call, after the user selects the assist device for the outgoing call, synchronizing data of the outgoing call with the assist device, and after the user selects the electronic device for the outgoing call, suspending the synchronization of the data of the outgoing call with the assist device.

A communication system according to a further exemplary embodiment of the present invention includes a main device for transmitting information for state synchronization about at least one function in a first situation, and suspending the transmission of the information for state synchronization in a second situation, and an assist device for receiving the information for state synchronization from the main device.

An operation method of an electronic device wirelessly connectable with a wearable device according to a yet another exemplary embodiment of the present invention includes the operations of, transmitting information for state synchronization about a call during controlling the call through the wearable device, and, suspending the transmission of the information for state synchronization about the call during controlling the call through the electronic device.

An electronic device connectable with an assist device includes a transceiver configured to couple the electronic device and the assist device, receive a signal for an incoming call by the electronic device, and synchronize the reception of the signal with the assist device, and a controller configured to determine through which one of the electronic device and the assist device a user attempts to receive the incoming call, after the user selects the assist device for the incoming call, cause the transceiver to synchronize data of the incoming call with the assist device, and after the user selects the electronic device for the incoming call, cause the transceiver to suspend the synchronization of the data of the incoming call with the assist device.

A communication system includes an assist device configured to couple the electronic device and the assist device, an electronic device configured to receive a signal for an incoming call by the electronic device, synchronize the reception of the signal with the assist device, determine through which one of the electronic device and the assist device a user attempts to receive the incoming call, after the user selects the assist device for the incoming call, cause the transceiver to synchronize data of the incoming call with the assist device, and after the user selects the electronic device for the incoming call, cause the transceiver to suspend the synchronization of the data of the incoming call with the assist device.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a schematic diagram illustrating a communication network according to an exemplary embodiment of the present disclosure;

FIG. 2 is a diagram illustrating an example of a main device and an assist device according to an exemplary embodiment of the present disclosure;

FIG. 3 is a ladder diagram illustrating signal exchange between a main device and an assist device according to an exemplary embodiment of the present disclosure;

FIG. 4 is a graph illustrating an example of an electric current consumption amount for state synchronization of an assist device according to an exemplary embodiment of the present disclosure;

FIG. 5 is a ladder diagram illustrating signal exchange between a main device and an assist device according to another exemplary embodiment of the present disclosure;

FIG. 6 is a graph illustrating another example of an electric current consumption amount for state synchronization of an assist device according to an exemplary embodiment of the present disclosure;

FIG. 7 is a ladder diagram illustrating signal exchange between a main device and an assist device according to a further another exemplary embodiment of the present disclosure;

FIG. 8 is a graph illustrating a further example of an electric current consumption amount for state synchronization of an assist device according to an exemplary embodiment of the present disclosure;

FIG. 9 is a flowchart illustrating an operation procedure of an electronic device according to an exemplary embodiment of the present disclosure;

FIG. 10 is a flowchart illustrating an operation procedure of an electronic device according to another exemplary embodiment of the present disclosure; and

FIG. 11 is a block diagram illustrating a construction of an electronic device according to an exemplary embodiment of the present disclosure.

### DETAILED DESCRIPTION

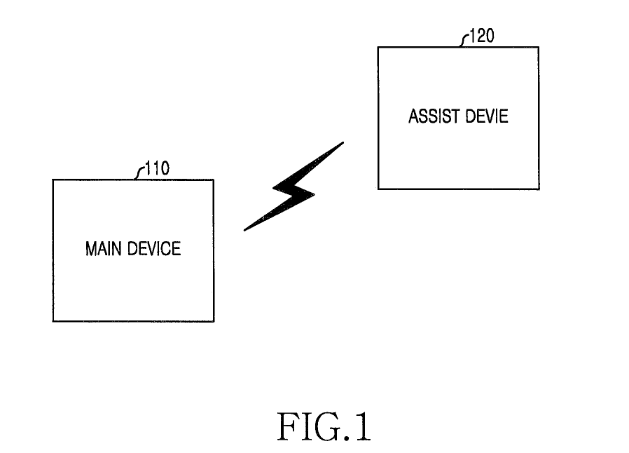

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. Preferred embodiments of the present disclosure will be described herein below with reference to the accompanying drawings. In the following description, well-known functions or constructions are not described in detail since they would obscure the disclosure in unnecessary detail. And, terms described below, which are defined considering functions in the present disclosure, can be modified in accordance to user and operator's intention or practice. Therefore, the terms should be defined on the basis of the disclosure throughout this specification.

Below, the present disclosure describes a technology for decreasing unnecessary electric power consumption of an assist device in an electronic device. In the present disclosure, the electronic device can be a portable electronic device, and can be one of a smart phone, a portable terminal, a mobile phone, a mobile pad, a media player, a tablet computer, a handheld computer, and a Personal Digital Assistant (PDA). Also, the electronic device can be a device coupling two or more functions among the aforementioned devices.

FIG. 1 illustrates a communication network according to an exemplary embodiment of the present disclosure.

Referring to FIG. 1, the main device 110 and the assist device 120 perform wireless communication and couple each other. The wireless communication between the main device 110 and the assist device 120 can be carried out on the basis of various technologies. For example, various short-range communication technologies can be used such as Bluetooth, Near Field Communication (NFC), Wireless Fidelity (WiFi) and the like.

The assist device 120 can control at least one function of the main device 110 through a wireless connection established with the main device 110. In other words, although a user does not directly handle the main device 110, the user can control at least one function of the main device 110 by handling the assist device 120. For example, by using the assist device 120, the user can turn on/off a power source of the main device 110, or receive a call received by the main device 110, or display an image stored in the main device 110. In accordance to an intention of an executor of the present disclosure, a concrete device characteristic and the like, the main device 110 can be denoted by a mother terminal, a major device and the like, and the assist device 120 can be denoted by a subordinate device, an accessory and the like.

When the user controls a function of the main device 110 through the assist device 120, the assist device 120 has to understand a state related to the function of the main device 110. For this, the main device 110 can provide the assist device 120 with information notifying the state related to the function of the main device 110. The information notifying the state can be provided to the assist device 120 at a time point at which the state is changed, or periodically. In accordance to this, the main device 110 and the assist device 120 can perform synchronization about the state. For description convenience's sake below, in various exemplary embodiments of the present disclosure, the ‘information notifying the state provided at the time point at which the state is changed or in accordance to a certain interval is denoted as ‘information for state synchronization’. Also, various exemplary embodiments of the present disclosure can be for a situation where the main device 110 and the assist device 120 are wirelessly connected or paired with each other. Also, in accordance to various exemplary embodiments of the present disclosure, exemplary embodiments of the present disclosure described below are applicable if it is a function of the main device 110. In accordance to the exemplary embodiments of the present disclosure, the function can include a function controllable through the assist device 120 or include a mutual function between the main device 110 and the assist device 120.

If a specific function is directly controlled through the main device 110, it can be interpreted that a user has no intention to control the specific function through the assist device 120. In this case, the main device 110 stops sharing state information about the function with the assist device 120, in other words, stops transmission of the information for state synchronization, thereby, is capable of decreasing unnecessary electric power consumption of the assist device 120. An electric power consumption value is different every main processor applied to each of the main device 110 and the assist device 120, but a main Application Processor (AP) commonly consumes the most electric current. According to an exemplary embodiment of the present disclosure, the number of times of activating the AP is decreased compared to the conventional art and thus, the effect of electric current improvement is expected.

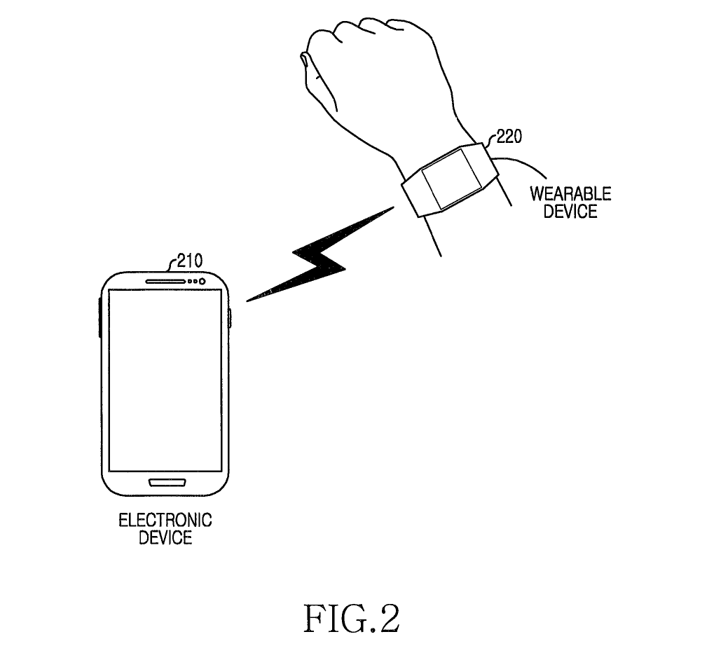

An exemplary embodiment of the present disclosure for decreasing electric power consumption is described below with reference to a concrete example of FIG. 2 below.

FIG. 2 illustrates an example of a main device and an assist device according to an exemplary embodiment of the present disclosure.

Referring to FIG. 2, the main device can be an electronic device 210 for call process, and the assist device can be a wearable device 220. In detail, the wearable device 220 can have forms of a watch, glasses and the like. The electronic device 210 can support at least one of cellular telephony, a Voice over Internet Protocol (VoIP), and the like.

The wearable device 220 has a microphone, a speaker and the like, and can play a role of a headset through a wired connection or wireless connection established with the main device (e.g., the electronic device 210). If the wearable device 220 has a function of the headset, a user can control call receiving and call originating through the wearable device 220. However, the wearable device 220 does not directly transmit/receive a signal for a call with a base station and the like, so the electronic device 210 provides information about a call state to the wearable device 220. In accordance to this, the wearable device 220 can perform state synchronization about the call with the electronic device 210. For example, when the wireless connection between the electronic device 210 and the wearable device 220 is established on the basis of the Bluetooth standard, a state of the call can be provided through AT command.

Unlike a conventional headset device having a major function of audio output and voice input, the wearable device 220 can have various functions other than the headset function. Particularly, the various functions other than the headset function can be of more significance relatively in accordance to a form of the wearable device 220 and a wear part thereof. Accordingly, although the wearable device 220 has the headset function, the wearable device 220 may not perform call control (e.g., call receiving, call originating, call maintenance, and the like). In other words, although the wearable device 220 has the headset function, the user can directly handle the electronic device 210 to receive or originate and make a call through the electronic device 210.

In a case where the user controls a call through the electronic device 210, transmitting the information for state synchronization about the call to the wearable device 220 results in unnecessary electric power consumption of the wearable device 220. In accordance to this, an exemplary embodiment of the present disclosure can determine the transmission or non-transmission of the information for state synchronization to the wearable device 220 in accordance to a call control situation.

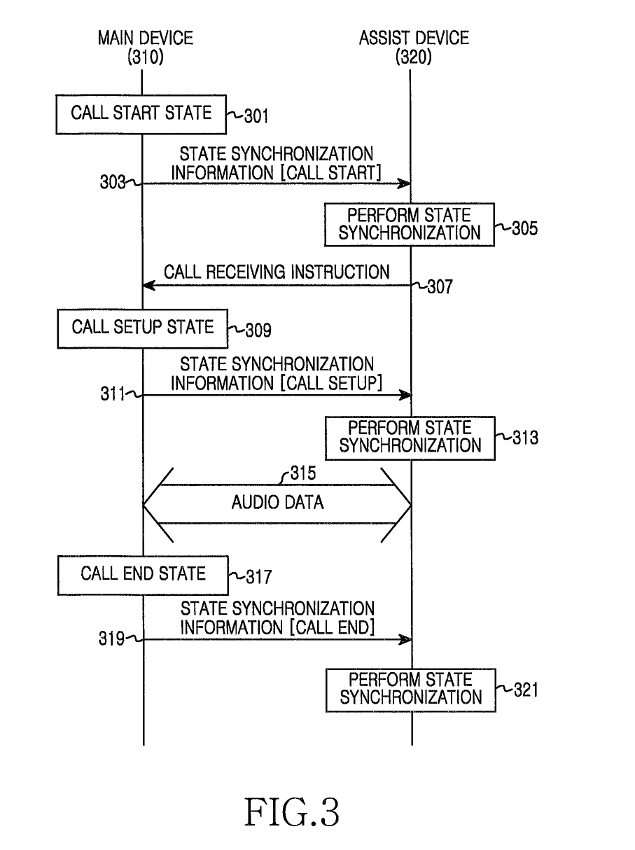

As described above, an electronic device, i.e., a main device according to an exemplary embodiment of the present disclosure can determine the transmission or non-transmission of the information for state synchronization to the assist device in accordance to a situation related to a specific function. For example, the specific function can include call process, and the situation can be whether a call is controlled through the assist device. If the specific function is a call, an example of signal exchange between the main device and the assist device is given as in FIG. 3 below.

FIG. 3 illustrates signal exchange between a main device and an assist device according to an exemplary embodiment of the present disclosure.

Referring to FIG. 3, in step 301, the main device 310 makes a transition to a call start state. For example, the main device 310 can determine transition or non-transition to the call start state on the basis of signaling with a base station or an AP for call reception and an internal procedure for call process.

In step 303, the main device 310 determining the call reception transmits information notifying call start to the assist device 320. In a case of the first call receiving situation, because it is not decided which subject controls a call, the main device 310 transmits state synchronization information notifying the call start to the assist device 320. For example, if a wireless connection between the main device 310 and the assist device 320 is established on the basis of e.g., Bluetooth™, the main device 310 transmits AT command notifying the call start to the assist device 320.

In step 305, the assist device 320 performs state synchronization about a call. That is, the assist device 320 recognizes a state of the call as the call start. For this, the assist device 320 can be equipped with an internal processor. Further to this, the assist device 320 can notify a user of an incoming call through a display means installed in the assist device 320.

In step 307, the assist device 320 recognizes the incoming call signal receiving through the assist device 320, and notifies the main device 310 of an instruction to receive the incoming call and forward it to the assist device 320. In other words, the assist device 320 can receive user's input for handling a call either through the assist device 320 for main device 310. For example, the user's input can be a hard key input, a touch input, and the like. Although not illustrated in FIG. 3, the main device 310 and the assist device 320 can establish an audio path for the purpose of audio data exchange for a call.

In step 309, the main device 310 makes a transition to a call setup state. For example, the main device 310 can determine transition or non-transition to the call connection state on the basis of signaling for call connection with the base station or AP and an internal procedure for call process.

In step 311, the main device 310 transmits information notifying call setup to the assist device 320. That is, the main device 310 determines that the call is controlled through the assist device 320, and transmits state synchronization information notifying the call setup to the assist device 320. For example, the main device 310 can determine that the call is controlled through the assist device 320 on the basis of the establishment or non-establishment of the audio path. At this time, if a wireless connection between the main device 310 and the assist device 320 is established on the basis of Bluetooth, the main device 310 transmits AT command notifying the call setup to the assist device 320.

In step 313, the assist device 320 receive performs the state synchronization based on the information received from main device 310. That is, the assist device 320 recognizes that call has been set up and connected. For this, the assist device 320 can operate the internal processor for the synchronization.

In step 315, the assist device 320 transmits/receives audio data transmitted/received for the call, with the main device 310. That is, because the user makes a call through the assist device 320, the assist device 320 can activate a microphone installed in the assist device 320 and receive an audio through the microphone, and output an audio through a speaker installed in the assist device 320. Accordingly, the assist device 320 transmits audio data inputted through the microphone, to the main device 310, and outputs audio data provided from the main device 310, through the speaker. If the call is a video call, the assist device 320 and the main device 310 can further exchange video data.

Once the incoming call has been ended in step 317, the main device 310 makes a transition to a call end state. At this time, the call can be ended in a counterpart's side or in the user side through either the main device 310 or the assist device 320. For example, the main device 310 can determine transition or non-transition to the call end state on the basis of signaling for call end with the base station or AP and an internal procedure for call process. Although not illustrated in FIG. 3, if the call is ended in the user's side, a signal requesting for the end of the call in the assist device 320 can be transmitted to the main device 310.

In step 319, the main device 310 transmits information notifying the call end to the assist device 320. That is, the main device 310 determines that the call is controlled through the assist device 320, and transmits state synchronization information notifying the call end to the assist device 320. For example, the main device 310 can determine that the call is controlled through the assist device 320 on the basis of the establishment or non-establishment of the audio path. At this time, if a wireless connection between the main device 310 and the assist device 320 is established on the basis of Bluetooth, the main device 310 transmits AT command notifying the call end to the assist device 320.

In step 321, the assist device 320 performs the state synchronization on the call status. That is, the assist device 320 recognizes the state of the call as the call end. For this, the assist device 320 can operate the internal processor.

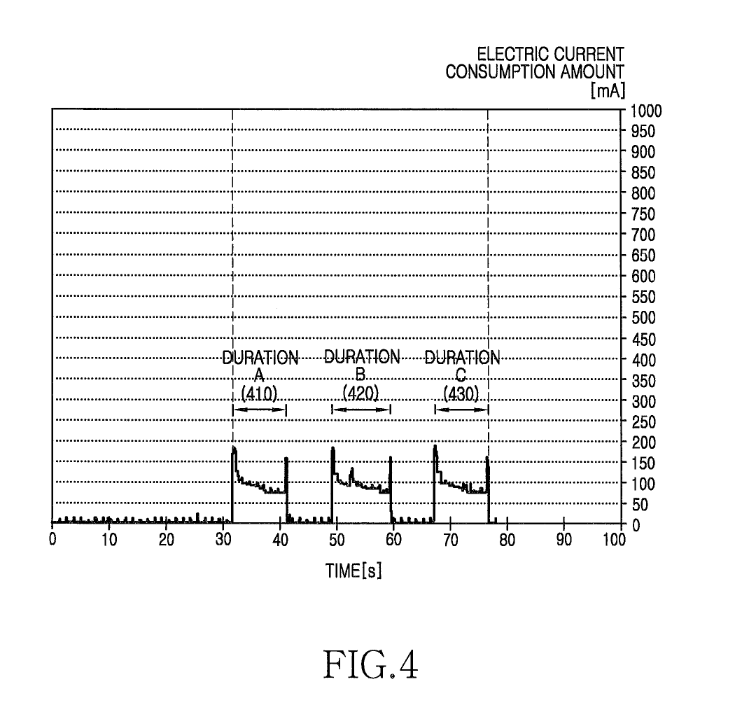

According to the exemplary embodiment of FIG. 3, as the call is controlled through the assist device 320, information about the call state is continuously provided from the main device 310 to the assist device 320. In this case, the electric current consumption of the assist device 320 is described as in FIG. 4 below. FIG. 4 illustrates an example of an electric current consumption amount for state synchronization of an assist device according to an exemplary embodiment of the present disclosure. Referring to FIG. 4, electric current consumption occurs at a time point at which a transition of a call state is made. In detail, electric current consumption for processing each information for state synchronization takes place in a duration A 410 in which the call start is notified, a duration B 420 in which the call setup is notified, and a duration C 430 in which the call end is notified. For example, in a case where the assist device 320 has a 1.2 Giga Hertz (GHz) dual processor, the electric current consumption of about 36 milli-Amperes (mA) for state synchronization is expected.

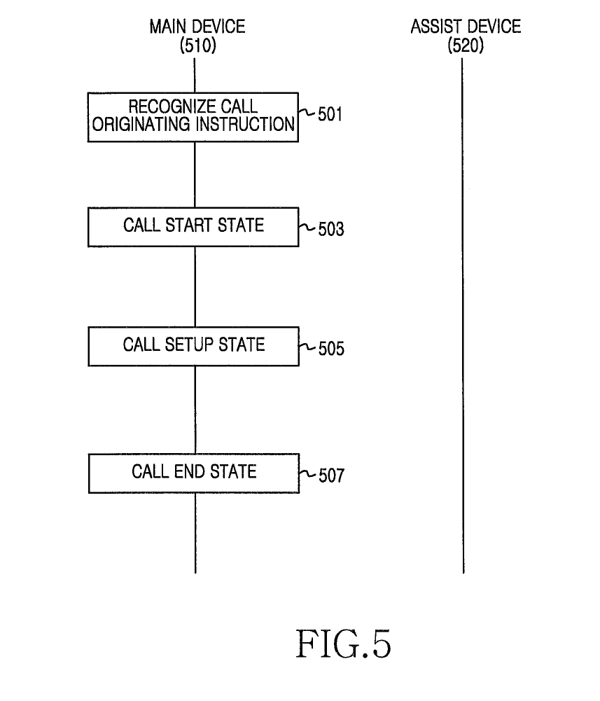

FIG. 5 illustrates signal exchange between a main device and an assist device according to another embodiment of the present disclosure.

Referring to FIG. 5, in step 501, the main device 510 recognizes the generation of a call originating instruction through the main device 510. In other words, the main device 510 recognizes user's handling for initiating a call through the main device 510. For example, the user's handling can be a hard key input, a touch input and the like corresponding to the call originating instruction after execution of an application for call originating.

In step 503, the main device 510 makes a transition to a call start state. For example, the main device 510 can determine transition or non-transition to the call start state on the basis of signaling for call receiving with a base station or AP and an internal procedure for call process. At this time, unlike the exemplary embodiment illustrated in FIG. 3, the call is controlled by the main device 510, so information notifying the call start state is not transmitted to the assist device 520.

In step 505, the main device 510 makes a transition to a call setup state. For example, the main device 510 can determine transition or non-transition to the call setup state on the basis of signaling for call connection with the base station or AP and an internal procedure for call process. At this time, unlike the exemplary embodiment illustrated in FIG. 3, the call is controlled by the main device 510, so information notifying the call setup state is not transmitted to the assist device 520.

In step 507, the main device 510 makes a transition to a call end state. At this time, the call can be ended in response to a counterpart's request or in response to a request of the user of the main device 510 and the assist device 520. For example, the main device 510 can determine transition or non-transition to the call end state on the basis of signaling for call end with the base station or AP and an internal procedure for call process. At this time, unlike the exemplary embodiment illustrated in FIG. 3, the call is controlled by the main device 510, so information notifying the call end state is not transmitted to the assist device 520.

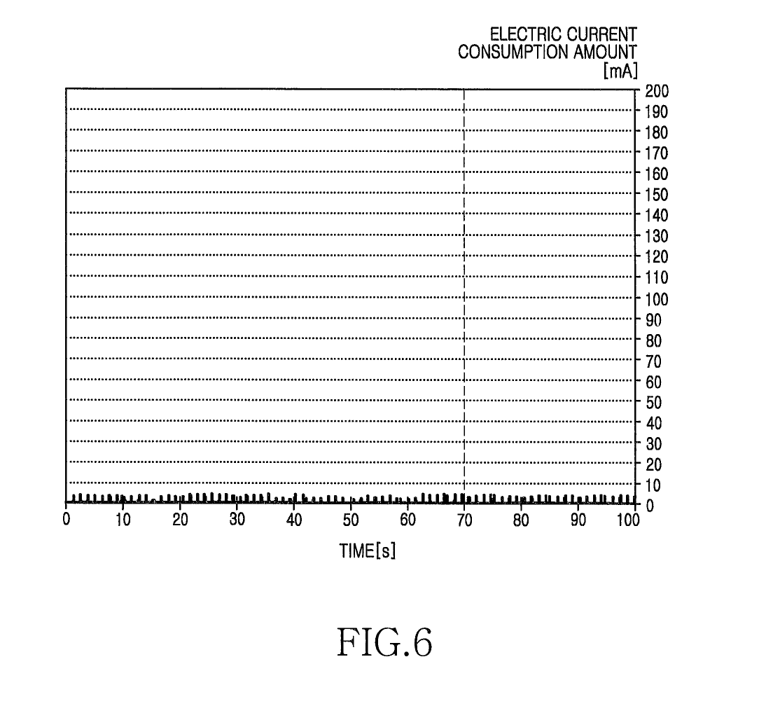

According to the exemplary embodiment of FIG. 5, as the call is controlled through the main device 510, information about the call state is not provided from the main device 510 to the assist device 520. In this case, the electric current consumption of the assist device 520 is described as in FIG. 6 below. FIG. 6 illustrates another example of an electric current consumption amount for state synchronization of an assist device according to an exemplary embodiment of the present disclosure. Referring to FIG. 6, electric current consumption for state synchronization does not take place because state synchronization information is not transmitted to the assist device. For example, in a case where the assist device has a 1.2 GHz dual processor, electric current saving of about 32 mA compared to a case of FIG. 4 is expected.

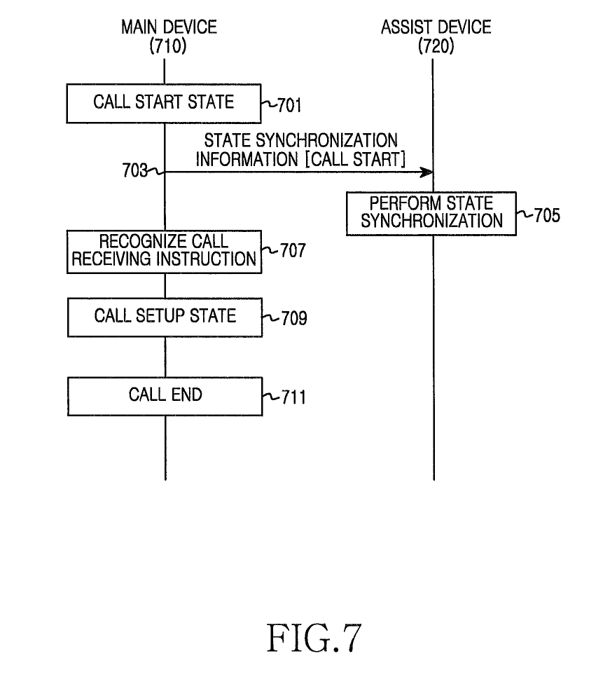

FIG. 7 illustrates signal exchange between a main device and an assist device according to a further another exemplary embodiment of the present disclosure.

Referring to FIG. 7, in step 701, the main device 710 makes a transition to a call start state. For example, the main device 710 can determine transition or non-transition to the call start state on the basis of signaling for call receiving with a base station or AP and an internal procedure for call process.

In step 703, the main device 710 determining the call receiving transmits information notifying call start to the assist device 720. In a case of the first call receiving situation, because it is not decided which subject controls a call, the main device 710 transmits state synchronization information notifying the call start to the assist device 720. For example, if a wireless connection between the main device 710 and the assist device 720 is established on the basis of Bluetooth, the main device 710 transmits AT command notifying the call start to the assist device 720.

In step 705, the assist device 720 performs a state synchronization on a call. As a result, the assist device 720 recognizes a state of the call receiving. For this, the assist device 720 can operate an internal processor. Further to this, the assist device 720 can notify a user of the generation of call receiving through a display means installed in the assist device 720.

In step 707, the main device 710 receives a user input instructing accepting the call through the main device 710. In other words, the main device 710 recognizes that user will handle the incoming call through the main device 710. For example, the user's input can be a hard key input, a touch input, and the like for call receiving.

In step 709, the main device 710 makes a transition to a call setup state. For example, the main device 710 can determine transition or non-transition to the call setup state on the basis of signaling for call connection with the base station or AP and an internal procedure for call process. At this time, unlike the exemplary embodiment illustrated in FIG. 3, the call is controlled by the main device 710, so information notifying the call setup state is not transmitted to the assist device 720.

In step 711, the main device 710 makes a transition to a call end state. At this time, the call can be ended in response to a counterpart's request or in response to a request of the user of the main device 710 and the assist device 720. For example, the main device 710 can determine transition or non-transition to the call end state on the basis of signaling for call end with the base station or AP and an internal procedure for call process. At this time, unlike the exemplary embodiment illustrated in FIG. 3, the call is controlled by the main device 710, so information notifying the call end state is not transmitted to the assist device 720.

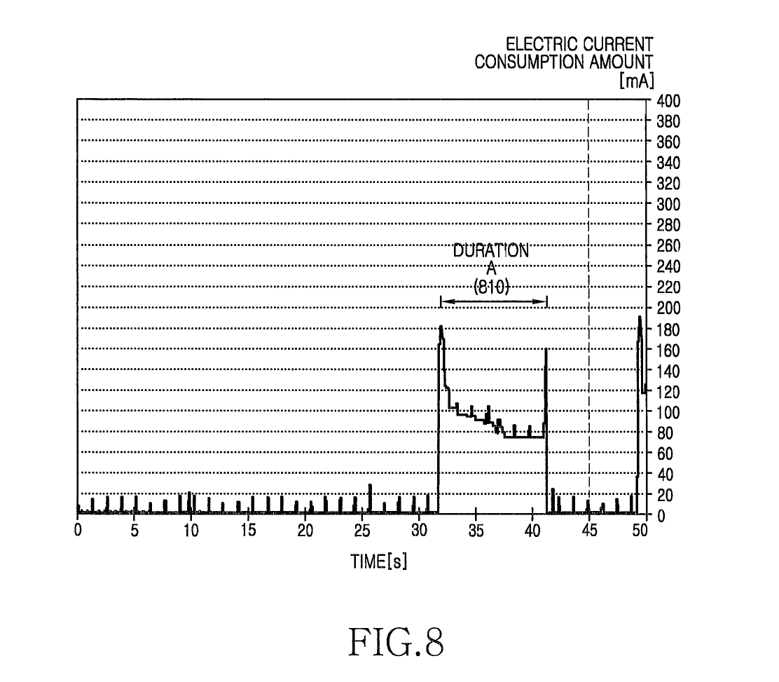

According to the exemplary embodiment of FIG. 7, as the call is controlled through the main device 710, information about the call state is not provided from the main device 710 to the assist device 720. In this case, the electric current consumption of the assist device 720 is described as in FIG. 8 below. FIG. 8 illustrates a further example of an electric current consumption amount for state synchronization of an assist device according to an exemplary embodiment of the present disclosure. Referring to FIG. 8, electric current consumption takes place only at a time point of notifying the first call start state. In detail, electric current consumption for processing information for state synchronization takes place in a duration A 810 in which call start is notified. For example, in a case where the assist device has a 1.2 GHz dual processor, electric current saving of about 32 mA compared to a case of FIG. 4 is expected.

The various exemplary embodiments described with reference to FIG. 3, FIG. 5, and FIG. 7 have described that state transitions related to a call are determined on the basis of signaling for call receiving/call initiating/call connection/call end and internal procedures for call process. But, a basis of determining the state transition can be varied in accordance to an intention of an executor of the present disclosure and a definition method of a state transition rule. The aforementioned examples do not intend to limit the spirit and scope of the present disclosure.

Also, in the various exemplary embodiments described with reference to FIG. 3, FIG. 5, and FIG. 7, the information for state synchronization is transmitted upon state transition. However, in accordance to another exemplary embodiment of the present disclosure, the information for state synchronization can be transmitted periodically in accordance to a constant interval of time. Or, in accordance to a further exemplary embodiment of the present disclosure, the information for state synchronization can be transmitted periodically as well as upon state transition.

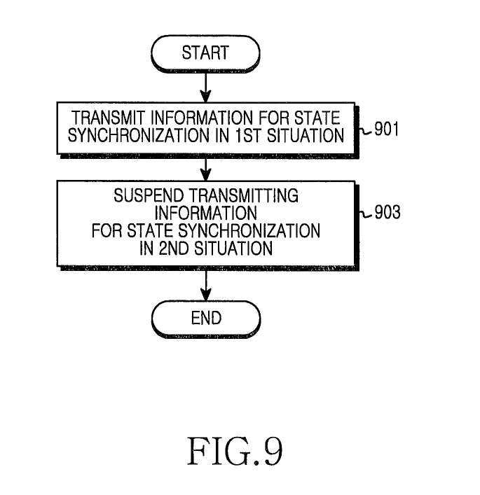

FIG. 9 illustrates an operation procedure of an electronic device according to an exemplary embodiment of the present disclosure.

Referring to FIG. 9, in step 901, the electronic device is under a first situation, and transmits information for state synchronization to an assist device. The information for state synchronization represents a state of at least one function. Here, the at least one function is provided by the electronic device, and can be controlled by the assist device or can be a mutual function between the electronic device and the assist device. The information for state synchronization can be transmitted upon state change occurrence or periodically.

After that, the electronic device proceeds to step 903 and is under a second situation, and stops transmitting the information for state synchronization to the assist device. That is, the transmitting of the information for state synchronization can be varied in accordance to situations. For example, the second situation can be a situation in which the function is controlled through the electronic device.

That is, in a case where the function is controlled through the assist device, the information for state synchronization is provided to the assist device, because the assist device has to understand a state related to the function. But, in a case where the function is controlled through the electronic device, sharing of the information for state synchronization can be stopped, because it does not matter that the assist device fails to understand the state related to the function.

For example, the function can be a call function. In this case, the state of the function can be one of call start, call setup, and call end. At this time, the second situation in which a call is controlled by the electronic device can be a situation of receiving a received call through the electronic device. For another example, the second situation can be a situation in which the call is maintained through the electronic device. That the call is maintained through the electronic device represents that a user makes a call through the electronic device. In detail, the second situation can include a situation in which a microphone installed in the electronic device is activated for audio input for the call, and a situation in which a speaker installed in the electronic device is activated for audio output for the call. For further example, the second situation can be a situation of originating the call through the electronic device.

The electronic device can determine the first situation or the second situation on the basis of the establishment or non-establishment of a communication path for controlling the function. Alternately, the electronic device can determine that it is the second situation as the electronic device receives a request for suspending of provision of the information for state synchronization from the assist device.

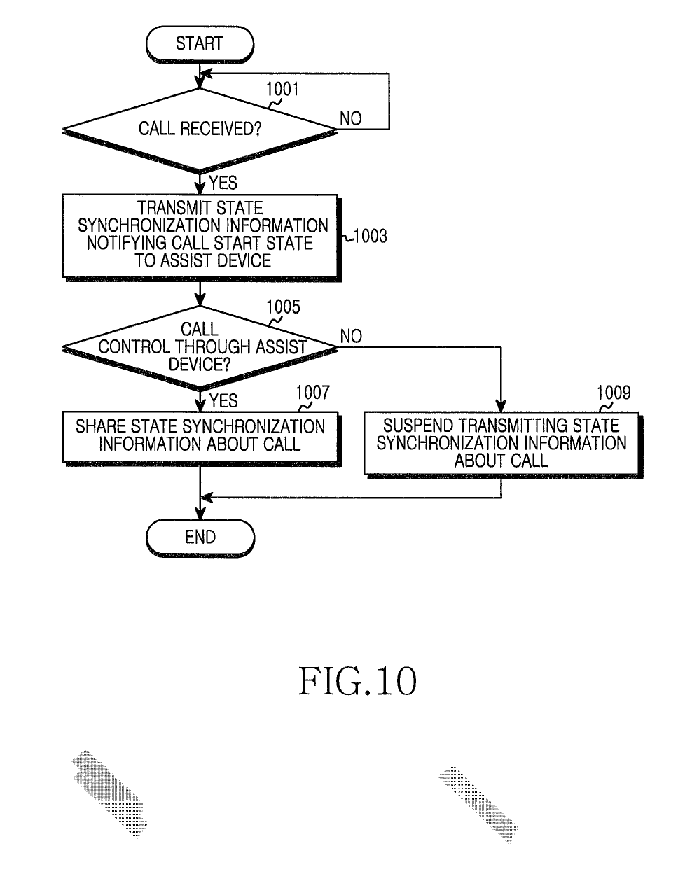

FIG. 10 illustrates an operation procedure of an electronic device according to another exemplary embodiment of the present disclosure.

Referring to FIG. 10, in step 1001, the electronic device determines if a call is received. For example, the call receiving or non-receiving can be determined by an application for call process. For example, the electronic device can determine the call receiving or non-receiving on the basis of signaling for call receiving with a base station or AP.

If the call is received, the electronic device proceeds to step 1003 and makes a transition to a call start state, and transmits state synchronization information notifying the call start state to an assist device. For example, if a wireless connection between the electronic device and the assist device is established on the basis of Bluetooth, the electronic device can transmit AT command including call state information to the assist device.

Next, the electronic device proceeds to step 1005 and determines if the call is controlled through the assist device. For example, the electronic device can determine if the call is controlled through the assist device on the basis of whether an audio path for transmitting/receiving audio data for the call has been established.

When the call is controlled through the assist device, the electronic device proceeds to step 1007 and keeps sharing the state synchronization information about the call. That is, as the state of the call makes a transition to a call setup state, a call end state and the like, the electronic device can transmit state synchronization information notifying one of the call setup state and the call end state to the assist device.

In contrast, when the call is not controlled through the assist device, in other words, when the call is controlled through the electronic device, the electronic device proceeds to step 1009 and stops sharing the state synchronization information about the call. In accordance to this, the unnecessary electric power consumption of the assist device can decrease.

The method described above in relation with FIG. 10 under of the present invention may be provided as one or more instructions in one or more software modules, or computer programs stored in an electronic device including a portable terminal.

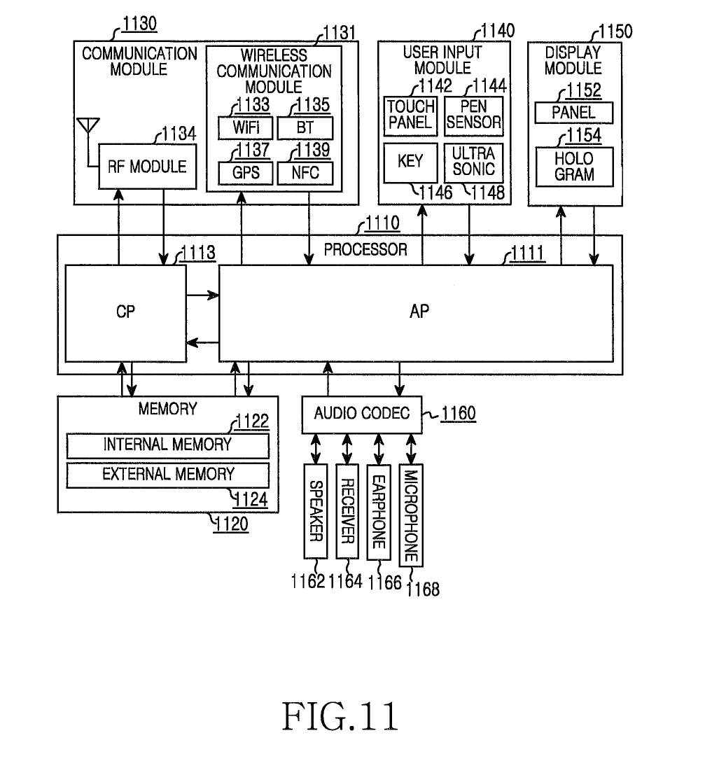

FIG. 11 illustrates a construction of an electronic device according to an exemplary embodiment of the present disclosure.

Referring to FIG. 11, the electronic device can include one or more processors 1110, a memory 1120, a communication module (e.g., transceiver) 1130, a user input module 1140, a display module 1150, and an audio codec 1160.

The processor 1110 can include one or more Application Processors (APs) 1111 or one or more Communication Processors (CPs) 1113. FIG. 11 illustrates that the AP 1111 and the CP 1113 are included within the processor 1110, but the AP 1111 and the CP 1113 can be included within different IC packages, respectively. In one exemplary embodiment, the AP 1111 and the CP 1113 can be included within one IC package, or one processor can play all of roles of the AP 1111 and the CP 1113.

The AP 1111 can drive an operating system or an application program to control a plurality of hardware or software constituent elements connected to the AP 1111, and perform processing and operations of various data including multimedia data. The AP 1111 can be implemented as a System on Chip (SoC), for example. According to one exemplary embodiment, the processor 1110 can further include a Graphic Processing Unit (GPU) (not shown).

The CP 1113 can perform a function of managing a data link and converting a communication protocol for communication between the electronic device and other electronic devices connected through a network. The CP 1113 can be implemented as a SoC, for example. According to one exemplary embodiment, the CP 1113 can perform at least a part of a multimedia control function. The CP 1113 can perform terminal distinction and authentication within a communication network using a subscriber identity module (e.g., a SIM card). Also, the CP 1113 can provide services such as voice telephony, video telephony, a text message, packet data or the like, to a user.

Also, the CP 1113 can control data transmission/reception of the communication module 1130. FIG. 11 illustrates the constituent elements such as the CP 1113, the memory 1120 and the like separate from the AP 1111, but, according to one exemplary embodiment, the AP 1111 can be implemented to include at least some (e.g., the CP 1113) of the aforementioned constituent elements.

According to one exemplary embodiment, the AP 1111 or the CP 1113 can load to a volatile memory an instruction or data received from a nonvolatile memory connected to each of the AP 1111 and the CP 1113 or received from at least one of other constituent elements, and process the loaded instruction or data. Also, the AP 1111 or the CP 1113 can store in the nonvolatile memory data which are received from at least one of the other constituent elements or are generated by at least one of the other constituent elements.

The memory 1120 can include an internal memory 1122 or an external memory 1124. The internal memory 1122 can include, for example, at least one of a volatile memory (e.g., a Dynamic Random Access Memory (DRAM), a Static Random Access Memory (SRAM), a Synchronous Dynamic Random Access Memory (SDRAM) and the like) or a nonvolatile memory (e.g., a One Time Programmable Read Only Memory (OTPROM), a Programmable ROM (PROM), an Erasable Programmable ROM (EPROM), an Electrically Erasable Programmable ROM (EEPROM), a mask Read Only Memory (ROM), a flash ROM, a Not AND (NAND) flash memory, a Not OR (NOR) flash memory and the like). According to one exemplary embodiment, the internal memory 1122 can take a form of a Solid State Drive (SSD). The external memory 1124 can further include Compact Flash (CF), Secure Digital (SD), Micro Secure Digital (Micro-SD), Mini Secure Digital (Mini-SD), extreme Digital (xD), a memory stick or the like, for example.

The communication module (transceiver) 1130 can include a wireless communication module 1131 or a Radio Frequency (RF) module 1134. The wireless communication module 1131 can include, for example, WiFi 1133, Bluetooth 1135, GPS 1137, and Near Field Communication (NFC) 1139. For example, the wireless communication module 1131 can provide a wireless communication function using radio frequency. Additionally or alternatively, the wireless communication module 1131 can include a network interface (e.g., a LAN card), a modem or the like for connecting the electronic device with a network (e.g., the Internet, a LAN, a WAN, a telecommunication network, a cellular network, a satellite network, a POTS or the like).

The RF module 1134 can take charge of transmission/reception of data, for example, transmission/reception of an RF signal or a called electrical signal. Though not illustrated, the RF module 1134 can include, for example, a transceiver, a Power Amp Module (PAM), a frequency filter, a Low Noise Amplifier (LNA) or the like. Also, the RF module 1134 can further include a component for transmitting/receiving an electromagnetic wave on a free space in wireless communication, for example, a conductor, a conductive line or the like.

The user input module 1140 can include a touch panel 1142, a (digital) pen sensor 1144, a key 1146, or an ultrasonic input device 1148. The touch panel 1142 can recognize a touch input by at least one of a capacitive method, a pressure sensitive method, an infrared method, and an ultrasonic method, for example. Also, the touch panel 1142 can further include a controller (not shown). In the capacitive method, not only direct touch but also proximity recognition is possible. The touch panel 1142 can further include a tactile layer. In this case, the touch panel 1142 can provide a tactile response to a user. The (digital) pen sensor 1144 can be implemented, for example, in a method being the same or similar to receiving a user's touch input or using a separate recognition sheet. The key 1146 can be, for example, a keypad or a touch key. The ultrasonic input device 1148 is a device capable of sensing a sound wave with a microphone (e.g., a microphone 1168) of the electronic device and identifying data with a pen generating an ultrasonic signal. The ultrasonic input device 1148 can do wireless recognition. According to one exemplary embodiment, the electronic device can use the communication module 1130 to receive a user input from an external device (e.g., a network, a computer, or a server) connected to the electronic device.

The display module 1150 can include a panel 1152 or a hologram 1154. The panel 1152 can be, for example, a Liquid Crystal Display (LCD), an Active-Matrix Organic Light-Emitting Diode (AMOLED), or the like. The panel 1152 can be implemented to be flexible, transparent, or wearable, for example. The panel 1152 can be constructed as one module together with the touch panel 1142. The hologram 1154 can show a three-dimensional image in the air by using interference of light. According to one exemplary embodiment, the display module 1150 can further include a control circuit for controlling the panel 1152 or the hologram 1154.

The audio codec 1160 can convert a voice and an electric signal interactively. The audio codec 1160 can convert voice information being inputted or outputted through a speaker 1162, a receiver 1164, an earphone 1166, the microphone 1168, or the like, for example.

In accordance to an exemplary embodiment of the present disclosure, the processor 1110 controls to provide state synchronization information to an assist device. Here, the assist device can perform wireless communication with the electronic device through the communication module 1130, and remotely control at least one function of the electronic device. For example, the processor 1110 can control the electronic device to perform procedures of FIGS. 3, 5, 7, 9, and 10. For this, the processor 1110 can include a module for sharing information for state synchronization in accordance to a situation. In accordance to another exemplary embodiment, the memory 1120 stores a software module including an instruction set for process works for sharing the information for state synchronization in accordance to the situation. The processor 1110 can execute the software module stored in the memory 1120. In accordance to a further exemplary embodiment, a separate hardware block for performing the process works can be provided. In accordance to a yet another exemplary embodiment, a function of performing the process works can be distributed and implemented in the processor 1110 and a separate processor.

In detail, the processor 1110 controls to transmit the information for state synchronization through the communication module 1130 in a first situation, and stop the transmission of the information for state synchronization in a second situation. The information for state synchronization represents a state of at least one function provided by the electronic device. Here, the function is controllable even through the assist device or is controllable only through the electronic device. That is, the transmitting of the information for state synchronization can be varied in accordance to situations. For example, the second situation can be a situation in which the function is controlled through the electronic device.

For example, the function can be a call function. In this case, the state of the function can be one of call start, call setup, and call end. At this time, the second situation in which a call is controlled by the electronic device can be a situation of receiving a received call through the electronic device. For another example, the second situation can be a situation in which the call is maintained through the electronic device. That the call is maintained through the electronic device represents that a user makes a call through the electronic device. In detail, the second situation can include a situation in which a microphone installed in the electronic device is activated for audio input for the call, and a situation in which a speaker installed in the electronic device is activated for audio output for the call. For further example, the second situation can be a situation of originating the call through the electronic device. The electronic device can determine the first situation or the second situation on the basis of the establishment or non-establishment of a communication path for controlling the function. Alternately, the electronic device can determine that it is the second situation as the electronic device receives a request for suspending of provision of the information for state synchronization from the assist device.

The names of the aforementioned constituent elements of hardware according to the present disclosure can be varied according to the kind of the electronic device. The hardware according to the present disclosure can include at least one of the aforementioned constituent elements, and can omit some constituent elements or further include additional other constituent elements. Also, some of the constituent elements of the hardware according to the present disclosure are coupled and constructed as one entity, thereby being able to perform functions of the corresponding constituent elements before coupled.

Exemplary embodiments of the present disclosure can prevent an unnecessary operation and decrease an electric power consumption amount, by synchronizing state information only at a required time point in an electronic device.

Embodiments of the present invention according to the claims and description in the specification can be realized in the form of hardware, software or a combination of hardware and software.

Such software may be stored in a computer readable storage medium. The computer readable storage medium stores one or more programs (software modules), the one or more programs comprising instructions, which when executed by one or more processors in an electronic device, cause the electronic device to perform methods of the present invention.

Such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disc (CD), Digital Video Disc (DVD), magnetic disk or magnetic tape or the like. It will be appreciated that the storage devices and storage media are embodiments of machine-readable storage that are suitable for storing a program or programs comprising instructions that, when executed, implement embodiments of the present invention. Embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

In the aforementioned detailed exemplary embodiments of the present disclosure, the constituent elements included in the disclosure have been expressed in the singular number or the plural number in accordance to the proposed detailed exemplary embodiments. But, the expression of the singular number or the plural number is selected adaptive to a proposed situation for description convenience's sake, and it is not that the present disclosure is limited to singular or plural constituent elements. Though the constituent elements are expressed in the plural number, the constituent elements can be constructed in the singular number or, though the constituent elements are expressed in the singular number, the constituent elements can be constructed in the plural number.

While the disclosure has been shown and described with reference to certain preferred embodiments thereof, it will be understood by those skilled in the art that various changes in form and details may be made therein without departing from the spirit and scope of the disclosure as defined by the appended claims.

What is claimed is:

1. A method for operating an electronic device wirelessly connectable with an assist device, the method comprising:
transmitting information for state synchronization about at least one function in a first situation; and
suspending the transmission of the information for state synchronization in a second situation.

2. The method of claim 1, wherein the second situation comprises a situation in which the at least one function is controlled through the electronic device.

3. The method of claim 1, wherein a state of the at least one function is one of call start, call setup, and call end.

4. The method of claim 3, wherein the second situation comprises at least one of a situation of receiving a call through the electronic device, a situation in which a microphone installed in the electronic device is activated for audio input for the call, a situation in which a speaker installed in the electronic device is activated for audio output for the call, and a situation of originating a call through the electronic device.

5. The method of claim 1, wherein the second situation comprises a situation of receiving a request for suspending of provision of the information for state synchronization, from the assist device.

6. The method of claim 1, wherein transmitting the information for state synchronization comprises the operation of transmitting a command signal comprising call state information.

7. The method of claim 1, further comprising:
determining the first situation or the second situation on the basis of the establishment or non-establishment of a communication path for controlling the at least one function between the electronic device and the assist device.

8. The method of claim 1, wherein the at least one function comprises a call receiving and originating function,
further comprising determining the first situation or the second situation on the basis of whether an audio path for transmitting and/or receiving audio data for the call has been established.

9. An electronic device connectable with an assist device, the device comprising:
a communication module configured to transmit information for state synchronization about at least one function in a first situation; and
a processor configured to suspend the transmission of the information for state synchronization in a second situation through the communication module.

10. The device of claim 9, wherein the second situation comprises a situation in which the at least one function is controlled through the electronic device.

11. The device of claim 9, wherein a state of the at least one function is one of call start, call setup, and call end.

12. The device of claim 11, wherein the second situation comprises at least one of a situation of receiving a call through the electronic device, a situation in which a microphone installed in the electronic device is activated for audio input for the call, a situation in which a speaker installed in the electronic device is activated for audio output for the call, and a situation of originating a call through the electronic device.

13. The device of claim 9, wherein the second situation comprises a situation of receiving a request for suspending of provision of the information for state synchronization, from the assist device.

14. The device of claim 9, wherein the communication module is configured to transmit a command signal comprising call state information.

15. The device of claim 9, wherein the processor is configured to determine the first situation or the second situation on the basis of the establishment or non-establishment of a communication path for controlling the at least one function between the electronic device and the assist device.

16. The device of claim 9, wherein the at least one function comprises a call receiving and originating function, and
the processor is further configured to determine the first situation or the second situation on the basis of whether an audio path for transmitting and/or receiving audio data for the call has been established.

17. A method for operating an electronic device wirelessly communicable with an assist device, the method comprising:
coupling the electronic device and the assist device;
receiving a signal for an incoming call by the electronic device;
synchronizing the reception of the signal with the assist device;
determining through which one of the electronic device and the assist device a user attempts to receive the incoming call;
after the user selects the assist device for the incoming call, synchronizing data of the incoming call with the assist device; and
after the user selects the electronic device for the incoming call, suspending the synchronization of the data of the incoming call with the assist device.

18. The method of claim 17, wherein after the user selects the assist device for the incoming call, upon detecting an end of the incoming call, the electronic device synchronizes the end of the call with the assist device.

19. The method of claim 17, wherein synchronizing the reception of the signal comprises notifying the assist device of receiving the signal of the incoming call.

20. The method of claim 17, further comprising:
determining through which one of the electronic device and the assist device the user attempts to initiating an outgoing call;
after the user selects the assist device for the outgoing call, synchronizing data of the outgoing call with the assist device; and
after the user selects the electronic device for the outgoing call, suspending the synchronization of the data of the outgoing call with the assist device.

21. An electronic device wirelessly connectable with an assist device, the device comprising:
a transceiver configured to:
couple the electronic device and the assist device wirelessly;
receive a signal for an incoming call by the electronic device; and
synchronize the reception of the signal with the assist device; and
a controller configured to:
determine through which one of the electronic device and the assist device a user attempts to receive the incoming call;
after the user selects the assist device for the incoming call, cause the transceiver to synchronize data of the incoming call with the assist device; and
after the user selects the electronic device for the incoming call, cause the transceiver to suspend the synchronization of the data of the incoming call with the assist device.

22. The electronic device of claim 21, wherein after the user selects the assist device for the incoming call, upon detecting an end of the incoming call, the electronic device is configured to synchronize the end of the call with the assist device.

23. The electronic device of claim 22, wherein the selection of the electronic device comprises at least one of situations of receiving a call through the electronic device, that a microphone installed in the electronic device is activated for audio input for the call, that a speaker installed in the electronic device is activated for audio output for the call, and initiating a call through the electronic device.

24. The electronic device of claim 21, wherein the selection of the electronic device comprises a situation of receiving a request for suspending of provision of the information for state synchronization, from the assist device.

25. The electronic device of claim 21, wherein synchronizing the reception of the signal comprises notifying the assist device of receiving the signal of the incoming call.

26. The electronic device of claim 21, further comprising:
determining through which one of the electronic device and the assist device the user attempts to initiating an outgoing call;
after the user selects the assist device for the outgoing call, synchronizing data of the outgoing call with the assist device; and
after the user selects the electronic device for the outgoing call, suspending the synchronization of the data of the outgoing call with the assist device.

27. A communication system comprising:
an assist device configured to:
couple the electronic device and the assist device;
an electronic device configured to:
receive a signal for an incoming call by the electronic device;
synchronize the reception of the signal with the assist device;
determine through which one of the electronic device and the assist device a user attempts to receive the incoming call;
after the user selects the assist device for the incoming call, cause the transceiver to synchronize data of the incoming call with the assist device; and
after the user selects the electronic device for the incoming call, cause the transceiver to suspend the synchronization of the data of the incoming call with the assist device.

28. The system of claim 27, wherein the assist device is a wearable device.

29. The system of claim 27, wherein after the user selects the assist device for the incoming call, upon detecting an end of the incoming call, the electronic device synchronizes the end of the call with the assist device.

30. The system of claim 27, wherein the selection of the electronic device comprises a situation of receiving a request for suspending of provision of the information for state synchronization, from the assist device.
